(19) United States
(12) Patent Application Publication
(10) Pub. No.: US 2025/0138397 A1
(43) Pub. Date: May 1, 2025

(54) BRACKET STRUCTURES FOR CAMERA LENS ASSEMBLIES

(71) Applicant: GoPro, Inc., San Mateo, CA (US)

(72) Inventors: Adrian Santos, Lake Forest, CA (US); Nicholas Vitale, Foster City, CA (US)

(21) Appl. No.: 18/385,517

(22) Filed: Oct. 31, 2023

(51) Int. Cl. G03B 17/12; G03B 17/56

(52) U.S. Cl. CPC G03B 17/12; G03B 17/565; G03B 17/566; G03B 2217/002

(57) ABSTRACT

An image capture device includes a body, an image sensor and lens assembly (ISLA) disposed in the body, and a bracket. The ISLA includes a barrel. The bracket includes a collar that is configured to removably clamp around the barrel of the ISLA and includes two or mounting structures that are coupled to the collar. The two or more mounting structures extend outward from the collar and are configured to connect the collar and the ISLA to the body.

### TECHNICAL FIELD

This disclosure relates to structural components for image capture devices. More specifically, this disclosure relates to bracketing configurations that enable the use of a common image sensor and lens assemblies across various implementations of image capture devices.

### BACKGROUND

Image capture devices are used in a variety of applications, including, for example, handheld camera and video recorders, cell phones, drones, vehicles, etc. Image capture devices typically include an optical module with one or more lenses (optical elements), which capture content by receiving and focusing light, and one or more image sensors, which convert the captured content into an electronic image signal that is processed by an image signal processor to form an image. In some image capture devices, the lens(es) and the image sensor(s) are combined into a single unit, which is known as an image sensor and lens assembly (ISLA).

An ISLA may include features (e.g., mounting structures) for securing the ISLA to other components of the image capture device (e.g., a body). Often, these features are unique to a specific image capture device implementation in order to accommodate various requirements (e.g., packaging constraints). Thus, an ISLA configured for use in one image capture device implementation may not be configured for use in another image capture device implementation. For example, an ISLA may include mounting structures that are configured to connect to a body of an image capture device, but which may not be configured to connect to a different body of a different image capture device.

Furthermore, omnidirectional image capture devices typically include a pair of ISLAs that are oriented in opposite (e.g., front and rear) directions. ISLAs used in these applications may include features (e.g., mounting structures) for fixing the pair of ISLAs relative to each other and/or for securing the pair of ISLAs to other components of the omnidirectional image capture device (e.g., a body). A similar challenge may present itself in omnidirectional image capture devices, for example, a pair of ISLAs may include mounting structures that are unique to a specific omnidirectional image capture device implementation.

### SUMMARY

In a first aspect, an image capture device includes a body, an image sensor and lens assembly (ISLA) disposed in the body, and a bracket. The ISLA includes a barrel. The bracket includes a collar that is configured to removably clamp around the barrel of the ISLA and includes two or more mounting structures coupled to the collar. The two or more mounting structures extend outward from the collar and are configured to connect the collar and the ISLA to the body.

In a second aspect, an image sensor and lens assembly (ISLA) includes a lens, an image sensor, a barrel, and a bracket. The barrel supports the lens and extends from the image sensor to the lens to define a longitudinal axis. The bracket includes a first portion and a second portion that are configured to cooperatively surround the barrel. The bracket includes a mounting structure that is configured to couple the bracket to a body of an image capture device. When the mounting structure is coupled to the body and the first portion and the second portion cooperatively surround the barrel, the bracket inhibits rotation of the ISLA about the longitudinal axis of the barrel.

In a third aspect, an image capture device includes a body, a first image sensor and lens assembly (ISLA), and a second ISLA. The first ISLA is supported by the body, is oriented in a first direction, and includes a first barrel. The second ISLA is supported by the body, is oriented in a second direction that is opposite the first direction, and includes a second barrel. The image capture device includes a first bracket that clamps around the first barrel and a second bracket that clamps around the second barrel. The first bracket is connected to the second bracket to fix a position of the first ISLA relative to that of the second ISLA. The second bracket is connected to the body to fix a position of the first ISLA and the second ISLA relative to the body.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture device.

FIGS. 2A-1B are isometric views of another example of an image capture device.

FIG. 3 is a top view of another example of an image capture device.

FIGS. 4A-4B are isometric views of another example of an image capture device.

FIG. 5 is a block diagram of electronic components of an image capture device.

FIG. 6 is an isometric view of an example of an image sensor and lens assembly (ISLA) for an image capture device.

FIG. 7 is an isometric view of a first example of a bracket that is connected to the ISLA of FIG. 6.

FIG. 8 is an isometric view of a second example of a bracket that is connected to the ISLA of FIG. 6.

FIG. 9 is an isometric view of a third example of a bracket that is connected to the ISLA of FIG. 6.

FIG. 10 is an isometric view of an assembly that includes the bracket of FIG. 7 and the bracket of FIG. 8.

FIGS. 11A-11B are isometric views of an assembly that includes the bracket of FIG. 7 and the bracket of FIG. 9.

### DETAILED DESCRIPTION

The present disclosure describes image capture devices with improved mounting structures that allow for the use of a common image sensor and lens assembly (ISLA) across various image capture device implementations. As indicated above, by including mounting structures on an ISLA that are unique to a specific image capture device implementation, multiple unique ISLAs must be employed to accommodate the different image capture device implementations that may be desired (e.g., different image capture device implementations across a product-line).

To reduce the number of unique ISLAs required to accommodate various image capture device implementations, rather than positioning mounting structures that are specific to the image capture device implementation on the ISLA itself, the image capture devices described herein position such mounting structures on a bracket that is separate from, but connectable to, different ISLAs. Thus, by positioning mounting structures that may be specific to a given image capture device implementation on a separate bracket, a common ISLA may be used with (e.g., as a component of) multiple different image capture device implementations.

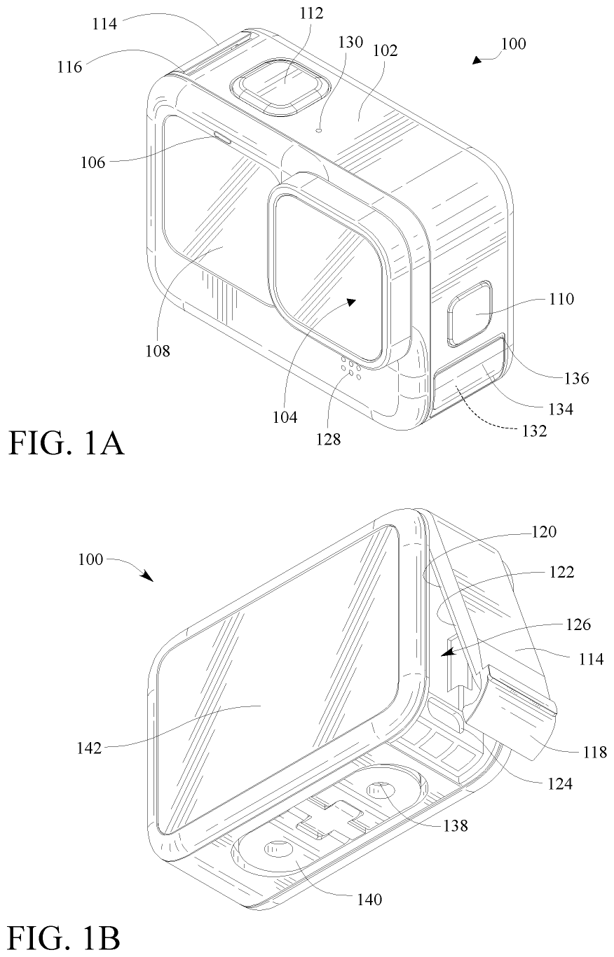

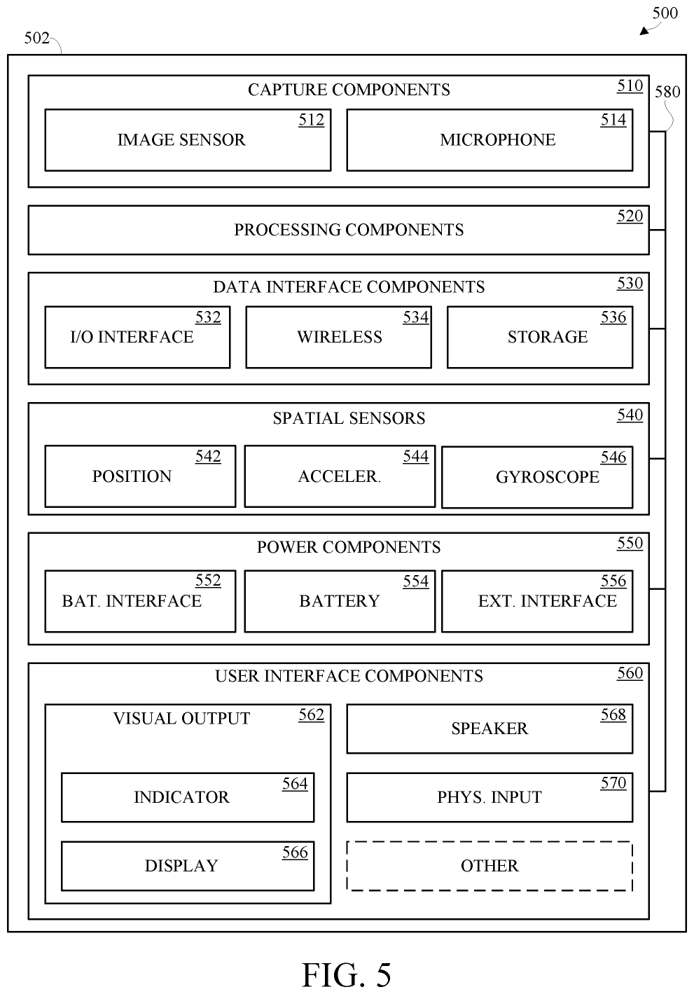

FIGS. 1A-1B are isometric views of an example of an image capture device 100. The image capture device 100 includes a body 102, an image sensor and lens assembly (ISLA) 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture device 100 includes internal electronics, such as imaging electronics, power electronics, and the like, internal to the body 102 for capturing images and performing other functions of the image capture device 100. An example showing internal electronics is shown in FIG. 5. The arrangement of the components of the image capture device 100 shown in FIGS. 1A-1B is an example, other arrangements of elements may be used, except as is described herein or as is otherwise clear from context.

The body 102 of the image capture device 100 may be made of a rigid material such as plastic, aluminum, steel, or fiberglass. Other materials may be used. The ISLA 104 is structured on a front surface of, and within, the body 102. The ISLA 104 includes a lens. The lens of the ISLA 104 receives light incident upon the lens of the ISLA 104 and directs the received light onto an image sensor of the ISLA 104 internal to the body 102. The image capture device 100 may capture one or more images, such as a sequence of images, such as video. The image capture device 100 may store the captured images and video for subsequent display, playback, or transfer to an external device. Although one ISLA 104 is shown in FIG. 1A, the image capture device 100 may include multiple ISLAs, which may be structured on respective surfaces of the body 102.

As shown in FIG. 1A, the image capture device 100 includes the indicator 106 structured on the front surface of the body 102. The indicator 106 may output, or emit, visible light, such as to indicate a status of the image capture device 100. For example, the indicator 106 may be a light-emitting diode (LED). Although one indicator 106 is shown in FIG. 1A, the image capture device 100 may include multiple indictors structured on respective surfaces of the body 102.

As shown in FIG. 1A, the image capture device 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture device 100. In some implementations, the display 108 may be omitted or combined with another component of the image capture device 100.

As shown in FIG. 1A, the image capture device 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture device 100 may include multiple mode, or configuration, buttons structured on respective surfaces of the body 102. In some implementations, the mode button 110 may be omitted or combined with another component of the image capture device 100. For example, the display 108 may be an interactive, such as touchscreen, display, and the mode button 110 may be physically omitted and functionally combined with the display 108.

As shown in FIG. 1A, the image capture device 100 includes the shutter button 112 structured on a top surface of the body 102. The shutter button 112 may be another type of input device, such as a switch, a toggle, a slider, or a dial. The image capture device 100 may include multiple shutter buttons structured on respective surfaces of the body 102. In some implementations, the shutter button 112 may be omitted or combined with another component of the image capture device 100.

The mode button 110, the shutter button 112, or both, obtain input data, such as user input data in accordance with user interaction with the image capture device 100. For example, the mode button 110, the shutter button 112, or both, may be used to turn the image capture device 100 on and off, scroll through modes and settings, and select modes and change settings.

As shown in FIG. 1B, the image capture device 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture device 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture device 100 includes the battery receptacle 126 structured to form a portion of an interior surface of the body 102. The battery receptacle 126 includes operative connections for power transfer between the battery and the image capture device 100. In some implementations, the battery receptacle 126 may be omitted. The image capture device 100 may include multiple battery receptacles.

As shown in FIG. 1A, the image capture device 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture device 100. The image capture device 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture device 100.

As shown in FIG. 1B, the image capture device 100 includes the speaker 138 structured on a bottom surface of the body 102. The speaker 138 outputs or presents audio, such as by playing back recorded audio or emitting sounds associated with notifications. The image capture device 100 may include multiple speakers structured on respective surfaces of the body 102.

As shown in FIG. 1B, the image capture device 100 includes the interconnect mechanism 140 structured on a bottom surface of the body 102. The interconnect mechanism 140 removably connects the image capture device 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture device 100 may include multiple interconnect mechanisms structured on, or forming a portion of, respective surfaces of the body 102. In some implementations, the interconnect mechanism 140 may be omitted.

As shown in FIG. 1B, the image capture device 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture device 100. The image capture device 100 may include multiple displays structured on respective surfaces of the body 102, such as the displays 108, 142 shown in FIGS. 1A-1B. In some implementations, the display 142 may be omitted or combined with another component of the image capture device 100.

The image capture device 100 may include features or components other than those described herein, such as other buttons or interface features. In some implementations, interchangeable lenses, cold shoes, and hot shoes, or a combination thereof, may be coupled to or combined with the image capture device 100. For example, the image capture device 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture device 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture device 100 via the computing communication link, or receive user input and communicate information with the image capture device 100 via the computing communication link. The external user interface device may implement or execute one or more applications to manage or control the image capture device 100. For example, the external user interface device may include an application for controlling camera configuration, video acquisition, video display, or any other configurable or controllable aspect of the image capture device 100. In some implementations, the external user interface device may generate and share, such as via a cloud-based or social media service, one or more images or video clips. In some implementations, the external user interface device may display unprocessed or minimally processed images or video captured by the image capture device 100 contemporaneously with capturing the images or video by the image capture device 100, such as for shot framing or live preview.

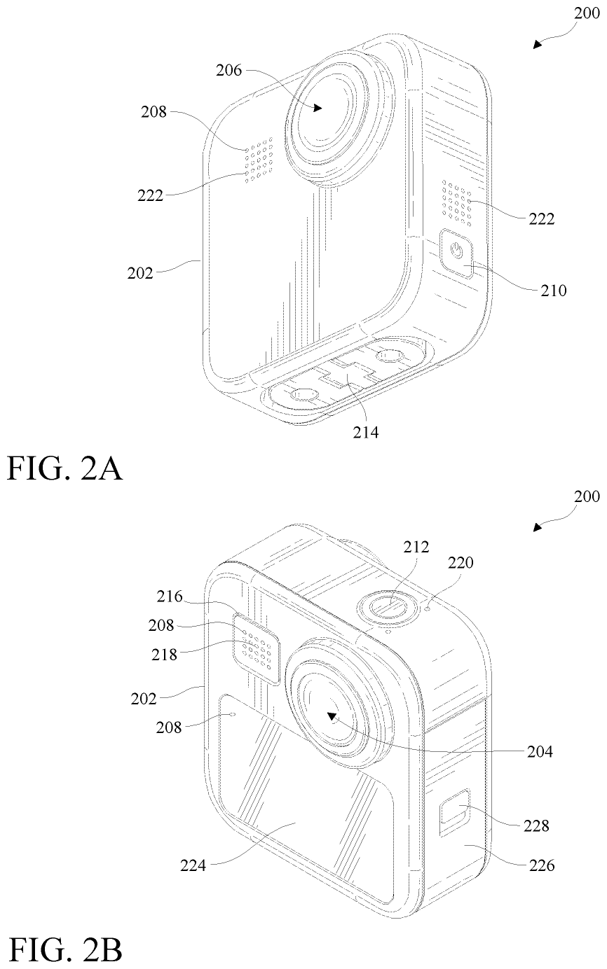

FIGS. 2A-2B illustrate another example of an image capture device 200. The image capture device 200 is similar to the image capture device 100 shown in FIGS. 1A-1B. The image capture device 200 includes a body 202, a first ISLA 204, a second ISLA 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture device 200 shown in FIGS. 2A-2B is an example, other arrangements of elements may be used.

The body 202 of the image capture device 200 may be similar to the body 102 shown in FIGS. 1A-1B. The first ISLA 204 is structured on a front surface of the body 202. The first ISLA 204 includes a first lens. The first ISLA 204 may be similar to the ISLA 104 shown in FIG. 1A. As shown in FIG. 2A, the image capture device 200 includes the second ISLA 206 structured on a rear surface of the body 202. The second ISLA 206 includes a second lens. The second ISLA 206 may be similar to the ISLA 104 shown in FIG. 1A. The ISLAs 204, 206 are disposed on opposing surfaces of the body 202, for example, in a back-to-back configuration, Janus configuration, or offset Janus configuration. The image capture device 200 may include other ISLAs structured on respective surfaces of the body 202.

As shown in FIG. 2B, the image capture device 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first ISLA 204 and another one of the indicators 208 may indicate a status of the second ISLA 206. Although two indicators 208 are shown in FIGS. 2A-2B, the image capture device 200 may include other indictors structured on respective surfaces of the body 202.

As shown in FIGS. 2A-2B, the image capture device 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture device 200 includes internal electronics (not expressly shown), such as imaging electronics, power electronics, and the like, internal to the body 202 for capturing images and performing other functions of the image capture device 200. An example showing internal electronics is shown in FIG. 5.

As shown in FIGS. 2A-2B, the image capture device 200 includes the interconnect mechanism 214 structured on a bottom surface of the body 202. The interconnect mechanism 214 may be similar to the interconnect mechanism 140 shown in FIG. 1B.

As shown in FIG. 2B, the image capture device 200 includes the drainage channel 216 for draining liquid from audio components of the image capture device 200.

As shown in FIGS. 2A-2B, the image capture device 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture device 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture device 200 may include multiple displays structured on respective surfaces of the body 202. In some implementations, the display 224 may be omitted or combined with another component of the image capture device 200.

As shown in FIG. 2B, the image capture device 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture device 200 may include features or components other than those described herein, some features or components described herein may be omitted, or some features or components described herein may be combined. For example, the image capture device 200 may include additional interfaces or different interface features, interchangeable lenses, cold shoes, or hot shoes.

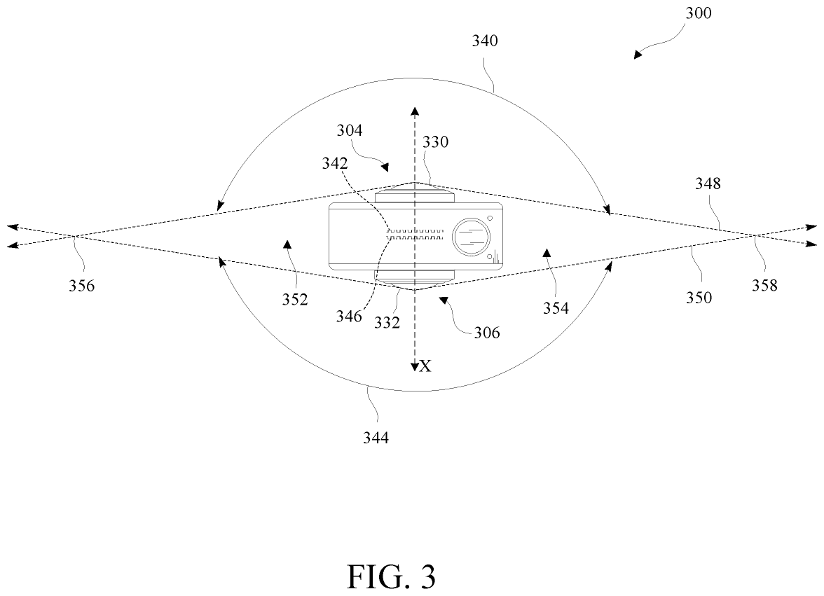

FIG. 3 is a top view of an image capture device 300. The image capture device 300 is similar to the image capture device 200 of FIGS. 2A-2B and is configured to capture spherical images.

As shown in FIG. 3, a first ISLA 304 includes a first lens 330 and a second ISLA 306 includes a second lens 332. For example, the first ISLA 304 may capture a first image, such as a first hemispheric, or hyper-hemispherical, image, the second ISLA 306 may capture a second image, such as a second hemispheric, or hyper-hemispherical, image, and the image capture device 300 may generate a spherical image incorporating or combining the first image and the second image, which may be captured concurrently, or substantially concurrently.

The first ISLA 304 defines a first field-of-view 340 wherein the first lens 330 of the first ISLA 304 receives light. The first lens 330 directs the received light corresponding to the first field-of-view 340 onto a first image sensor 342 of the first ISLA 304. For example, the first ISLA 304 may include a first lens barrel (not expressly shown), extending from the first lens 330 to the first image sensor 342.

The second ISLA 306 defines a second field-of-view 344 wherein the second lens 332 receives light. The second lens 332 directs the received light corresponding to the second field-of-view 344 onto a second image sensor 346 of the second ISLA 306. For example, the second ISLA 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the ISLAs 304, 306 are arranged in a back-to-back (Janus) configuration such that the lenses 330, 332 face in opposite directions, and such that the image capture device 300 may capture spherical images. The first image sensor 342 detects a first hyper-hemispherical image plane from light entering the first lens 330. The second image sensor 346 detects a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture device 300, may be obscured from the lenses 330, 332 and the corresponding image sensors 342, 346, such that content corresponding to the uncaptured areas 352, 354 may be omitted from images captured by the image capture device 300. In some implementations, the ISLAs 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously detected by the respective image sensors 342, 346 may be combined to form a combined image, such as a spherical image. Generating a combined image may include correlating the overlapping regions detected by the respective image sensors 342, 346, aligning the captured fields-of-view 340, 344, and stitching the images together to form a cohesive combined image. Stitching the images together may include correlating the overlap points 356, 358 with respective locations in corresponding images detected by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the ISLAs 304, 306, such as of the lenses 330, 332, the image sensors 342, 346, or both, may change the relative positions of the respective fields-of-view 340, 344, may change the locations of the overlap points 356, 358, such as with respect to images detected by the image sensors 342, 346, and may change the uncaptured areas 352, 354, which may include changing the uncaptured areas 352, 354 unequally.

Incomplete or inaccurate information indicating the alignment of the ISLAs 304, 306, such as the locations of the overlap points 356, 358, may decrease the accuracy, efficiency, or both of generating a combined image. In some implementations, the image capture device 300 may maintain information indicating the location and orientation of the ISLAs 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture device 300 (not shown), or laterally offset and off-center from the central axis (not shown). Whether through use of offset or through use of compact ISLAs 304, 306, a reduction in distance between the lenses 330, 332 along the axis X may improve the overlap in the fields-of-view 340, 344, such as by reducing the uncaptured areas 352, 354.

Images or frames captured by the ISLAs 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

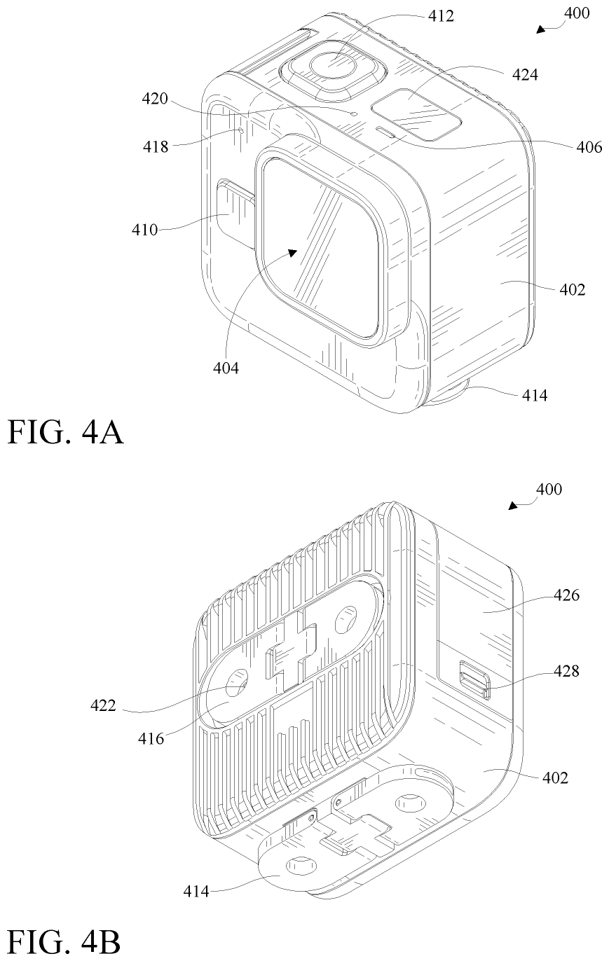

FIGS. 4A-4B illustrate another example of an image capture device 400. The image capture device 400 is similar to the image capture device 100 shown in FIGS. 1A-1B and to the image capture device 200 shown in FIGS. 2A-2B. The image capture device 400 includes a body 402, an ISLA 404, an indicator 406, a mode button 410, a shutter button 412, interconnect mechanisms 414, 416, audio components 418, 420, 422, a display 424, and a door 426 including a release mechanism 428. The arrangement of the components of the image capture device 400 shown in FIGS. 4A-4B is an example, other arrangements of elements may be used.

The body 402 of the image capture device 400 may be similar to the body 102 shown in FIGS. 1A-1B. The ISLA 404 is structured on a front surface of the body 402. The ISLA 404 includes a lens and may be similar to the ISLA 104 shown in FIG. 1A.

As shown in FIG. 4A, the image capture device 400 includes the indicator 406 on a top surface of the body 402. The indicator 406 may be similar to the indicator 106 shown in FIG. 1A. The indicator 406 may indicate a status of the ISLA 204. Although one indicator 406 is shown in FIGS. 4A, the image capture device 400 may include other indictors structured on respective surfaces of the body 402.

As shown in FIGS. 4A, the image capture device 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture device 400 includes internal electronics (not expressly shown), such as imaging electronics, power electronics, and the like, internal to the body 402 for capturing images and performing other functions of the image capture device 400. An example showing internal electronics is shown in FIG. 5.

As shown in FIGS. 4A-4B, the image capture device 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture device 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture device 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture device 400 may include multiple displays structured on respective surfaces of the body 402. In some implementations, the display 424 may be omitted or combined with another component of the image capture device 200.

As shown in FIG. 4B, the image capture device 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture device 400 may include features or components other than those described herein, some features or components described herein may be omitted, or some features or components described herein may be combined. For example, the image capture device 400 may include additional interfaces or different interface features, interchangeable lenses, cold shoes, or hot shoes.

FIG. 5 is a block diagram of electronic components in an image capture device 500. The image capture device 500 may be a single-lens ISLA, a multi-lens ISLA, or variations thereof, including an image capture device with multiple capabilities such as the use of interchangeable ISLAs. Components, such as electronic components, of the image capture device 100 shown in FIGS. 1A-1B, the image capture device 200 shown in FIGS. 2A-2B, the image capture device 300 shown in FIG. 3, or the image capture device 400 shown in FIGS. 4A-4B, may be implemented as shown in FIG. 5.

The image capture device 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an image sensor 512 for detecting images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 detects light as image data and conveys the image data as electrical signals (image signals or image data) to the other components of the image capture device 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with image detection by the image sensor 512. The microphone 514 may detect sound to receive audible commands to control the image capture device 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture device 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture device 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture device 500 and the memory card, such as for storing images, recorded audio, or both captured by the image capture device 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture device 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture device 500, which may include obtaining, such as by receiving, temporal data, such as via a GPS signal. The accelerometer 544, which may be a three-axis accelerometer, may measure linear motion, linear acceleration, or both of the image capture device 500. The gyroscope 546, which may be a three-axis gyroscope, may measure rotational motion, such as a rate of rotation, of the image capture device 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture device 500 for operating the image capture device 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture device 500. The battery interface 552 may be similar to the battery receptacle 126 shown in FIG. 1B. The external power interface 556 obtains or receives power from an external source, such as a wall plug or external battery, and distributes the power to the components of the image capture device 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture device 500, output, such as display or present, information to a user, or both receive input and output information, such as in accordance with user interaction with the image capture device 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture device 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture device 500. The physical input interface 570 may be, for example, a button, a toggle, a switch, a dial, or a slider.

As shown in FIG. 5, the user interface components 560 include a broken line border box labeled “other” to indicate that components of the image capture device 500 other than the components expressly shown as included in the user interface components 560 may be user interface components. For example, the microphone 514 may receive, or capture, and process audio signals to obtain input data, such as user input data corresponding to voice commands. In another example, the image sensor 512 may detect, receive, or otherwise process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

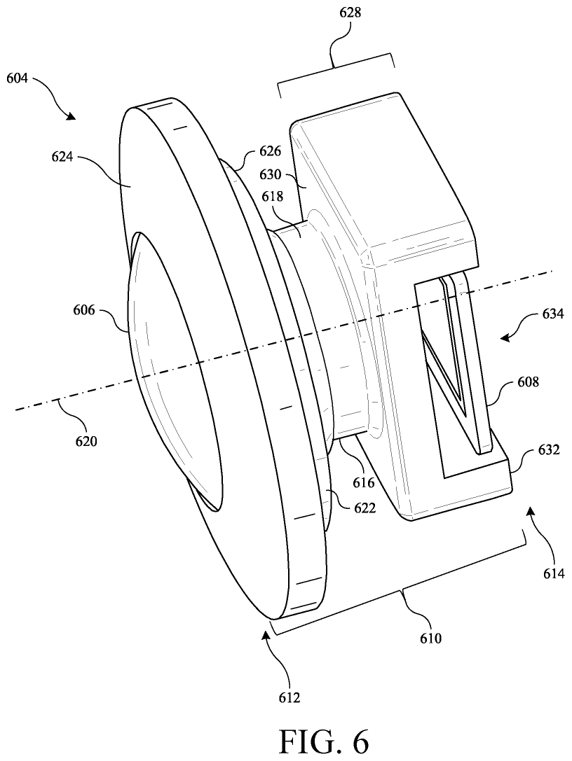

FIG. 6 is an isometric view of an image sensor and lens assembly (ISLA) 604 for an image capture device. The ISLA 604 may be similar to any of the ISLAs 104, 204, 206, 304, 306, 404, described above. As is described in further detail below, the ISLA 604 may be configured to be usable with (e.g., as a component of) multiple different implementations of image capture devices (e.g., image capture devices 100, 200, 300, 400, 500 or some other implementation of an image capture device). An image capture device may include a body that defines a body cavity inside which the ISLA 604, or portions thereof, may be disposed. The body of the image capture device may include an ISLA opening that extends from the body cavity to an external environment, and through which the ISLA 604, or portions thereof, may extend. The ISLA 604 may be connected to the body of the image capture device to secure (e.g., fix) the ISLA 604 relative to the body and within the ISLA opening.

Different implementations of image capture devices may include different bodies having different body geometries. Furthermore, different implementations of image capture devices may include different configurations of components disposed within the body cavity of the image capture device. Accordingly, each implementation of an image capture device may include a unique mounting configuration for an ISLA based on the geometry of the body and/or based on the configuration of components disposed within the body cavity. For example, an implementation of an image capture device may include a body having three mounting features (e.g., three apertures or bosses) that are spaced around an ISLA opening for connecting an ISLA thereto. Thus, an ISLA used in this image capture device implementation may require three corresponding structural members to connect to the three mounting features of the body. Another implementation of an image capture device may include a different body having four mounting features (e.g., four apertures or bosses) that are spaced around an ISLA opening for connecting an ISLA thereto. Thus, an ISLA used in this image capture device implementation may require four corresponding structural members to connect to the four mounting features of the body.

Therefore, to enable the ISLA 604 to be usable with (e.g., as a component of) different image capture device implementations having different bodies and corresponding different mounting configurations, the ISLA 604 may omit mounting structures that directly connect the ISLA 604 to the mounting features of the body. Instead, the ISLA 604 may be indirectly connected to the mounting features of the body via a bracket. As is described in further detail below, different implementations of brackets may be employed to accommodate different image capture device implementations having different mounting configurations.

Referring to FIG. 6, the ISLA 604 may include a lens 606 and an image sensor 608 that are supported by a housing 610. The lens 606 may be similar to the lenses 330, 332, and the image sensor 608 may be similar to the image sensors 342, 346, 512, described above. The housing 610 may be made of a rigid material such as plastic, aluminum, steel, or composite. Other materials may be used. The lens 606 may be configured to direct light incident on the lens 606 along an optical axis, here, coincident with a longitudinal axis 620 as described below, and onto the image sensor 608. The term optical axis as used herein refers to an axis along which light generally travels from the lens 606 to the image sensor 608.

The lens 606 may be supported by the housing 610 on a first end 612 of the housing 610, and the image sensor 608 may be supported by the housing 610 on a second end 614 of the housing 610 that is opposite the first end 612. The housing 610 may further include a barrel 616 that extends from the first end 612 to the second end 614 to space the lens 606 apart from the image sensor 608 along the optical axis. The barrel 616 is opaque and surrounds the optical axis to inhibit unwanted light (e.g., light from inside a body cavity of an image capture device) from entering the barrel 616 and to inhibit light traveling between the lens 606 and the image sensor 608 (e.g., light traveling along the optical axis) from exiting the barrel 616. As an example, the barrel 616 may be substantially tubular, wherein the optical axis may extend through an opening of the barrel 616 that extends from the first end 612 to the second end 614 of the housing 610 (e.g., from the lens 606 to the image sensor 608). In such an implementation, the barrel 616 may have an outer surface 618 that is substantially cylindrical. The barrel 616 may include optical elements (e.g., internal lenses, mirrors, etc.) disposed in the opening of the barrel 616 that are configured to further direct light from the lens 606 to the image sensor 608 (e.g., to further direct light along the optical axis).

Still referring to FIG. 6, in some implementations, the barrel 616 may extend linearly from the first end 612 of the housing 610 to the second end 614 of the housing 610 to define a longitudinal axis 620. In the implementation shown in FIG. 6, the optical axis is consistent with the longitudinal axis 620. In other implementations, the barrel 616 may not extend linearly from the first end 612 to the second end 614, but may instead include bent portions (e.g., may instead include a ninety-degree bend) between the first end 612 and the second end 614. In such an implementation, optical elements (e.g., internal lenses, mirrors, etc.) may be disposed in the opening of the barrel 616 to route the optical axis along the bent portions.

As shown in FIG. 6, the first end 612 of the housing 610 may include a flange 622 that is configured to support the lens 606. The flange 622 may extend radially outward from the barrel 616 (e.g., radially outward from the longitudinal axis 620). The flange 622 includes a first side 624 and a second side 626. The first side 624 is oriented generally away from the second end 614 of the housing 610 along the longitudinal axis 620 and may include a planar face that is substantially normal to the longitudinal axis 620. The second side 626 is opposite the first side 624 and is oriented generally toward the second end 614 of the housing 610 along the longitudinal axis 620. The lens 606 may be supported by (e.g., connected to) the housing 610 on the first side 624 of the flange 622 or between the first side 624 and the second side 626 of the flange, such as within a collar. In some implementations, the first side 624 of the flange 622 may include features for retaining the lens 606 thereto. For example, the first side 624 may include detents, recesses, threads, or the like that are configured to interface with complementary features of the lens 606. In other implementations, the first end 612 of the housing 610 may include some other geometry for supporting the lens 606.

The second end 614 of the housing 610 may include an image sensor portion 628 that is configured to support the image sensor 608. As shown in FIG. 6, the image sensor portion 628 of the housing 610 may extend radially outward from the barrel 616 (e.g., radially outward from the longitudinal axis 620) to form a base 630 that is generally rectangular. The image sensor portion 628 may also include stanchions or ribs 632 (e.g., two of the ribs 632) that extend away from laterally opposite sides of the base 630 in a direction that is generally away from the first end 612 of the housing 610 and parallel with the longitudinal axis 620. The ribs 632 may define a recess 634 in which the image sensor 608 may be disposed. The ribs 632 may be operable to protect the image sensor 608 from physical damage by providing a rigid barrier along sides of the image sensor 608. In other implementations, the image sensor portion 628 may include some other geometry for supporting the image sensor 608. For example, in some implementations, the base 630 of the image sensor portion 628 may be generally circular, triangular, or some other shape. As another example, the ribs 632 of the image sensor portion 628 may extend around an entire periphery of the base 630 to provide a rigid barrier along all sides of the image sensor 608. As another example, the image sensor portion 628 may omit the ribs 632 altogether. The image sensor 608 may be secured to the image sensor portion 628 via any suitable means, including, for example, via adhesives, clips, fasteners, or the like.

As described above, to enable the ISLA 604 to be usable with (e.g., as a component of) different image capture device implementations, the housing 610 of the ISLA 604 lacks mounting structures for securing the housing 610 directly to a body of an image capture device. Rather, the housing 610 of the ISLA 604 may be connectable to a bracket that includes such mounting structures. Different implementations of the bracket may be employed to accommodate different mounting configurations of image capture device implementations with which the ISLA 604 may be used.

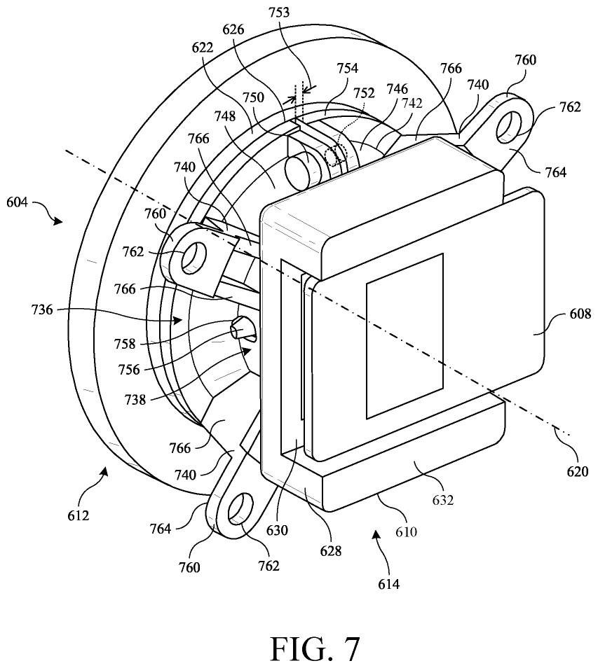

FIG. 7 is an isometric view of a first example of a bracket 736 that is connected to the ISLA 604 of FIG. 6. The bracket 736 is configured to couple to the housing 610 of the ISLA 604 between the image sensor 608 and the lens 606 (with respect to the longitudinal axis 620). The bracket 736 may include a collar 738 and mounting structures 740. The collar 738 may be configured to extend around an outer diameter of (e.g., surround) the barrel 616 (see FIG. 6) to secure the bracket 736 to the ISLA 604. The mounting structures 740 are configured to connect the collar 738 and the ISLA 604 to a body of an image capture device and to secure (e.g., fix) the ISLA 604 relative to the body. The bracket 736 may be made of a rigid material such as plastic, aluminum, steel, or composite. Other materials may be used.

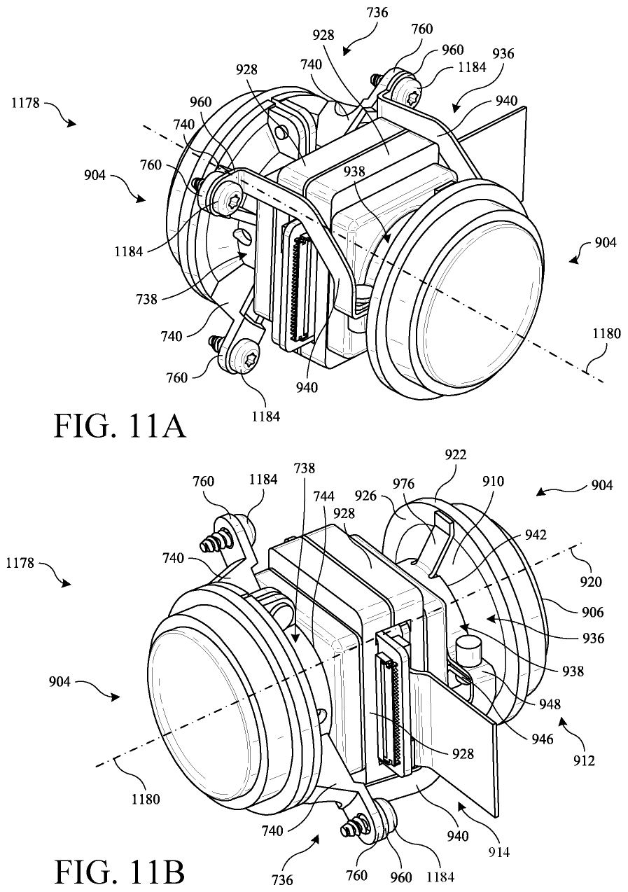

The collar 738 includes a first edge 742 that, when the bracket 736 is coupled to the housing 610, is proximate to the first end 612 of the housing 610 and includes a second edge 744 (see FIG. 11B) that is opposite the first edge 742 and proximate to the second end 614 of the housing 610. The collar 738 may include an inner surface that is complementary to the outer surface 618 (see FIG. 6) of the barrel 616. Accordingly, in implementations where the outer surface 618 of the barrel 616 is substantially cylindrical, the collar 738 may have an inner surface that is substantially cylindrical to complement the outer surface 618 of the barrel 616.

In some implementations, the collar 738 may be comprised of multiple portions. For example, referring to FIG. 7, the collar 738 may be comprised of a first portion 746 and a second portion 748 that are configured to cooperatively surround the barrel 616. Accordingly, each of the first portion 746 and the second portion 748 may include a portion of the first edge 742 and a portion of the second edge 744 of the collar 738. The first portion 746 of the collar 738 may be configured to receive a first portion of the barrel 616 (e.g., may be configured to extend around a first portion of the barrel 616) and the second portion 748 of the collar 738 may be configured to receive a second portion of the barrel 616 (e.g., may be configured to extend around a second portion of the barrel 616). The first portion of the barrel 616 and the second portion of the barrel 616 may be defined by longitudinally dividing the barrel 616, such as in a manner that bisects the barrel 616 or divides the barrel 616 along a plane the extends through the longitudinal axis 620, such that the first portion and the second portion of the barrel 616 are halves of the barrel 616. In such an implementation, the first portion 746 and the second portion 748 are each configured to receive substantially half of the barrel 616 (e.g., are configured to extend around substantially half of the barrel 616). Accordingly, in implementations where the outer surface 618 of the barrel 616 is substantially cylindrical, the inner surfaces of the first portion 746 and the second portion 748 may be substantially semicylindrical to complement the outer surface 618 of the barrel 616.

In other implementations, the first portion 746 of the collar 738 may be substantially U-shaped, such that the first portion 746 is configured to receive substantially all of the barrel 616, and the second portion 748 may be configured to connect ends of the first portion 746 such that the first portion 746 and the second portion 748 cooperatively surround the barrel 616. In other implementations, the first portion 746 may be configured to receive some other fraction of the barrel 616, and the second portion 748 may be configured to receive the remaining fraction of the barrel 616.

Still referring to FIG. 7, the first portion 746 of the collar 738 is configured to connect to the second portion 748 of the collar 738 to secure the bracket 736 to the barrel 616 and/or to exert a clamping force upon the barrel 616. In the implementation shown in FIG. 7, the first portion 746 includes a boss 750 and the second portion 748 includes a through hole 752 (shown in dotted line as hidden). A threaded fastener extends through the through hole 752 and into the boss 750 to connect the first portion 746 to the second portion 748. Furthermore, there may remain a gap 753 between the first portion 746 and the second portion 748, such that when the gap 753 is reduced (e.g., when the threaded fastener is tightened) a clamping force is applied to the barrel 616. Other means of connecting the first portion 746 to the second portion 748 may be used. For example, the first portion 746 and the second portion 748 may each include a through hole through which a bolt may extend and be received by a nut to secure the first portion 746 to the second portion 748. Other examples include the use of rivets, clamps, clips, or the like to secure the first portion 746 to the second portion 748. In some implementations, the first portion 746 may be connected to the second portion 748 at multiple (e.g., two) locations around the barrel 616 (e.g., at upper and lower locations around the barrel 616). Where the first portion 746 is connected to the second portion 748 at only one location around the barrel 616, the collar 738 may include a hinge (e.g., a living hinge, a pinned hinge, etc.) to enable the collar 738 to be opened and closed around the barrel 616.

To ensure that the ISLA 604 is accurately positioned within a body of an image capture device, the collar 738 may be configured to secure (e.g., fix) the ISLA 604 at a certain position along the longitudinal axis 620 relative to the bracket 736. In some implementations, the collar 738 may secure the ISLA 604 at a position along the longitudinal axis 620 by exerting a clamping force on the barrel 616 such that friction between the collar 738 and the barrel 616 inhibits translation of the barrel 616 along the longitudinal axis 620 relative to the bracket 736. Furthermore, the inner surface of the collar 738 and/or the outer surface 618 of the barrel 616 may include texture (e.g., knurling) to increase friction between the barrel 616 and the collar 738.

Additionally or alternatively, the housing 610 may include an axial locating feature and the collar 738 may include a complementary axial locating feature that are configured to interface to inhibit translation of the ISLA 604 along the longitudinal axis 620 relative to the bracket 736. In the implementation shown in FIG. 7, the axial locating feature of the housing 610 is the flange 622 and the complementary axial locating feature of the collar 738 is a complementary flange 754 that is configured to interface with (e.g., contact) the second side 626 of the flange 622. When the collar 738 is clamped around the barrel 616, the complementary flange 754 may contact the second side 626 of the flange 622 and thereby inhibit translation of the collar 738 along the longitudinal axis 620 toward the first end 612 of the housing 610 (e.g., toward the lens 606) relative to the ISLA 604.

The complementary flange 754 may extend radially outward from the first edge 742 of the collar 738. The complementary flange 754 may include a surface that is complementary to the second side 626 of the flange 622. In the implementation shown in FIG. 7, the complementary flange 754 extends around an entirety of the first edge 742 of the collar 738 (e.g., around an entire periphery of the collar 738). In other implementations, the complementary flange 754 may extend around only a portion of the first edge 742 of the collar 738 (e.g., around only a portion of the periphery of the collar 738). In implementations where the collar 738 is comprised of multiple portions (e.g., the first portion 746 and the second portion 748), the complementary flange 754 may extend along only one of the first edge 742 of the first portion 746 or along the first edge 742 of the second portion 748. In other implementations, the complementary flange 754 may be omitted, and the axial locating feature of the housing 610 may be the flange 622 and the complementary axial locating feature of the collar 738 may be the first edge 742. In such an implementation, the first edge 742 may be configured to interface with (e.g., contact) the second side 626 of the flange 622 to inhibit translation of the collar 738 along the longitudinal axis 620 toward the first end 612 of the housing 610 (e.g., toward the lens 606) relative to the bracket 736.

In some implementations, the housing 610 may include another axial locating feature and the collar 738 may include another complementary axial locating feature that are configured to interface to further inhibit translation of the ISLA 604 along the longitudinal axis 620 relative to the bracket 736. The other axial locating feature of the housing 610 may be the base 630 of the image sensor portion 628 and the other complementary axial locating feature of the collar 738 may be the second edge 744. In such an implementation, the second edge 744 may be configured to interface with (e.g., contact) the base 630 of the image sensor portion 628 to inhibit translation of the collar 738 along the longitudinal axis 620 toward the second end 614 of the housing 610 (e.g., toward the image sensor 608) relative to the ISLA 604. Other configurations of axial locating features and complementary axial locating features may be used. By use of multiple axial locating features, the collar 738 is configured to constrain motion of the ISLA 604 to preserve function of the ISLA 604 when integrated in an image capture device.

Furthermore, to ensure that the ISLA 604 is accurately oriented within a body of an image capture device, the collar 738 may be configured to secure (e.g., fix) the ISLA 604 at a certain orientation about the longitudinal axis 620 of the barrel 616 such that the ISLA 604 does not rotate within or relative to the bracket 736. In some implementations, the collar 738 may secure the ISLA 604 at an orientation by exerting a clamping force on the barrel 616 such that friction between the collar 738 and the barrel 616 inhibits rotation of the barrel 616 about the longitudinal axis 620.

Additionally or alternatively, the housing 610 of the ISLA 604 may include a rotational locating feature and the collar 738 may include a complementary rotational locating feature that are configured to interface to inhibit rotation of the ISLA 604 about the longitudinal axis 620 of the barrel 616. For example, in the implementation shown in FIG. 7, the housing 610 of the ISLA 604 includes a protruding member 756 (e.g., a locating pin) that extends radially outward from the barrel 616 (e.g., radially outward from the longitudinal axis 620) and the collar 738 includes a locating aperture 758 that is configured to receive the protruding member 756. When the collar 738 is clamped around the barrel 616, the locating aperture 758 may receive the protruding member 756 such that interference between the locating aperture 758 and the protruding member 756 inhibits rotation of the ISLA 604 about the longitudinal axis 620. In other implementations, the rotational locating feature of the housing 610 may instead be a recessed portion located on the barrel 616 and the complementary rotational locating feature of the collar 738 may be a protruding member that extends radially inward toward the barrel 616 (e.g., radially inward toward the longitudinal axis 620). When the collar 738 is clamped around the barrel 616, the recessed portion of the housing 610 may receive the protruding member of the collar 734 such that interference between the recessed portion and the protruding member inhibits rotation of the ISLA 604 about the longitudinal axis 620. Other configurations of rotational locating features and complementary rotational locating features may be used.

The protruding member 756 of the housing 610 and the locating aperture 758 of the collar 738 may also be operable to inhibit translation of the ISLA 604 along the longitudinal axis 620 relative to the bracket 736. For example, when the collar 738 is clamped around the barrel 616, the locating aperture 758 may receive the protruding member 756, such that interference between the locating aperture 758 and the protruding member 756 inhibits translation of the collar 738 along the longitudinal axis 620 toward the first end 612 of the housing 610 (e.g., toward the lens 606) and/or toward the second end 614 of the housing 610 (e.g., toward the image sensor 608).

The bracket 736 includes mounting structures 740 that are configured to connect the collar 738 and the ISLA 604 to a body of an image capture device and to secure (e.g., fix) the ISLA 604 relative to the body. The mounting structures 740 may correspond to the mounting configuration of the image capture device implementation with which the ISLA 604 is used. Referring to FIG. 7, as an example, a body of an image capture device may include three mounting features (e.g., three apertures or bosses) that are positioned at about 45 degrees, 225 degrees, and 315 degrees around an ISLA opening for securing an ISLA, such as the ISLA 604, thereto. Accordingly, the bracket 736 may include three of the mounting structures 740 at the same positions around the collar 738 that are configured to connect to the three mounting features of the body. By providing three points of contact between the bracket 736 and the body of the image capture device, a plane may be defined for orienting the ISLA 604 relative to the body. Other implementations of image capture devices having a different number and/or configuration of mounting features may require that the bracket 736 include a different number and/or configuration of the mounting structures 740.

Still referring to FIG. 7, the mounting structures 740 are elongated members (e.g., arms) that extend generally outward from the collar 738 and terminate at ends 760. In some implementations, the mounting structures 740 may extend radially outward from the collar 738 (e.g., radially outward from the longitudinal axis 620 when the collar 738 is clamped around the barrel 616). Furthermore, the mounting structures 740 may extend radially outward from the collar 738 and may also extend in another direction (e.g., toward the first end 612 of the housing 610 or toward the second end 614 of the housing 610 when the collar 738 is clamped around the barrel 616).

The ends 760 may be configured to connect to mounting features of a body of an image capture device. For example, in the implementation shown in FIG. 7, the ends 760 of the mounting structures 740 include mounting apertures 762 that are configured to align with corresponding mounting features (e.g., apertures or bosses) of the body. Respective fasteners may extend through the mounting apertures 762 of the bracket 736 and into the corresponding mounting features of the body to secure the bracket 736 to the body. Furthermore, the ends 760 include mounting surfaces 764 that may be complementary to corresponding mounting surfaces of the body, such that the mounting surfaces 764 of the bracket 736 may interface with (e.g., contact) the corresponding mounting surfaces of the body when the bracket 736 is connected to the body.

The mounting structures 740 may include ribs 766 that are configured to stiffen the mounting structures 740 to support the collar 738 and the ISLA 604 at a fixed position relative to a body of an image capture device. Referring to FIG. 7, each of the mounting structures 740 include two of the ribs 766 that are positioned laterally adjacent to one another to space the ends 760 of the mounting structures 740 away from the collar 738 at locations spaced about the longitudinal axis 620. Other configurations of the ribs 766 may be used.

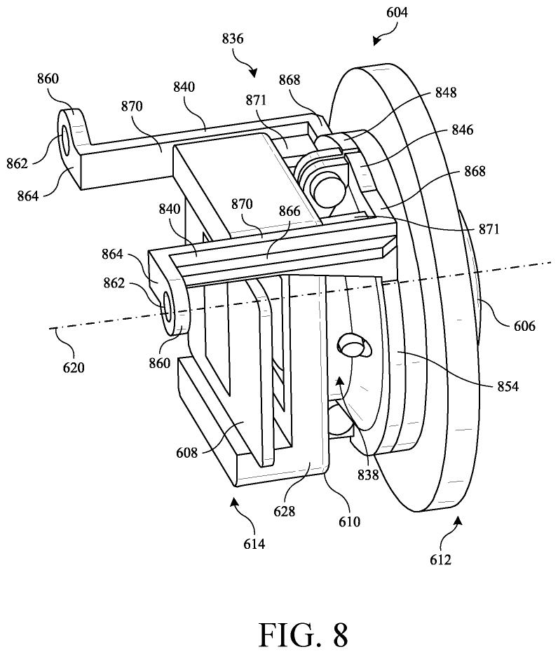

FIG. 8 is an isometric view of a second example of a bracket 836 that is connected to an ISLA, here, the ISLA 604 of FIG. 6. The bracket 836 may be similar to the bracket 736 described with respect to FIG. 7. The bracket 836 includes a collar 838 that is similar to the collar 738 and that may include a first portion 846 and a second portion 848 that cooperatively surround the barrel 616 (see FIG. 6) of the ISLA 604. The first portion 846 may be connected to the second portion 848 via one or more fasteners (e.g., a bolt, a screw, a rivet, etc.) that extend through the first portion 846 and the second portion 848. The fastener 972 may be received by a boss, a nut, or the like. The first portion 846 may be connected to the second portion 848 via one or more fasteners (e.g., bolts, screws, rivets, etc.). For example, the first portion 846 may include two bosses located at upper and lower locations around the barrel 616 and the second portion 848 may include two corresponding through holes. Respective fasteners may extend through the through holes of the second portion 848 and into the bosses of the first portion 846 to connect the first portion 846 to the second portion 848. Other means of connecting the first portion 846 to the second portion 848 may be used.

Furthermore, the collar 838 of the bracket 836 may include a complementary rotational locating feature that may interface with a rotational locating feature of the barrel 616. For example, the collar 838 of the bracket 836 may include an aperture that is configured to receive the protruding member 756 (see FIG. 7) of the barrel 616 to inhibit rotation of the ISLA 604 about the longitudinal axis 620 and inhibit rotation between the ISLA 604 and the bracket 836. The bracket 836 also includes mounting structures 840 that may be similar to the mounting structures 740 and that extend generally away from the collar 838 to terminate at ends 860. The ends 860 of the mounting structures 840 include mounting apertures 862 and mounting surfaces 864 that are similar to the mounting apertures 762 and the mounting surfaces 764 described with respect to FIG. 7.

In some implementations, a body of an image capture device may include only two mounting features (e.g., apertures or bosses) for securing an ISLA, such as the ISLA 604, thereto. Accordingly, the bracket 836 includes only two of the mounting structures 840 that are configured to connect to the two mounting features of such a body. Furthermore, in some implementations, a body of an image capture device may include an ISLA opening and mounting features for an ISLA that are positioned on opposite (e.g., front and rear) sides of the body. For example, a body of an image capture device may include an ISLA opening that extends through a front side of the body and may include mounting features for an ISLA on a rear side of the body that is opposite the front side. To accommodate such a body configuration, the mounting structures 840 each include a radially extending portion 868 and an axially extending portion 870. The radially extending portion 868 extends radially away from the collar 838 (e.g., radially away from the longitudinal axis 620 when the collar 838 is clamped around the barrel 616). The axially extending portion 870 extends from the radially extending portion 868 in an axial direction that is parallel with the longitudinal axis 620 and toward the second end 614 of the housing 610 when the collar 838 is clamped around the barrel 616.

Referring to FIG. 8, the axially extending portions 870 of the mounting structures 840 terminate at locations that, when the collar 838 is clamped around the barrel 616, are spaced from or beyond the image sensor 608 and the image sensor portion 628 of the housing 610 with respect to the longitudinal axis 620. Therefore, where a body of an image capture device includes mounting structures positioned on a rear side of the body and an ISLA opening positioned on a front side of the body, the mounting structures 840 may extend beyond the image sensor portion 628 of the housing 610 of the ISLA 604 to secure the ISLA 604 to the rear side of the body while supporting the ISLA 604 as it extends cantilevered through the body and into the ISLA opening on the front side of the body.

As shown in FIG. 8, the collar 838 may include a complementary flange 854 that is similar to the complementary flange 754 described with respect to FIG. 7 and the radially extending portions 868 of the mounting structures 840 may extend from the complementary flange 854. As shown in FIG. 8, the axially extending portions 870 of the mounting structures 840 may contact sides of the image sensor portion 628 to form a frame around the image sensor portion 628. By forming a frame around the image sensor portion 628 of the housing 610, the axially extending portions 870 of the mounting structures 840 may be operable to inhibit rotation of the ISLA 604 about the longitudinal axis 620 relative to the bracket 836. Furthermore, by contacting the image sensor portion 628 of the housing 610, the image sensor portion 628 may provide structural support to (e.g., may stiffen) the mounting structures 840 to further prevent the ISLA 604 from moving relative to the body of the image capture device.

Furthermore, one or more of the mounting structures 834 may include ribs 866 that are configured to provide structural support (e.g., stiffen) the mounting structures 840 to further prevent the ISLA 604 from moving relative to the body of the image capture device. In the implementation shown in FIG. 8, the ribs 866 are disposed along the axially extending portions 870 of the mounting structures 834. The mounting structures 834 may also include gussets 871 that are disposed between the axially extending portions 870 and the radially extending portions 868 to provide structural support therebetween.

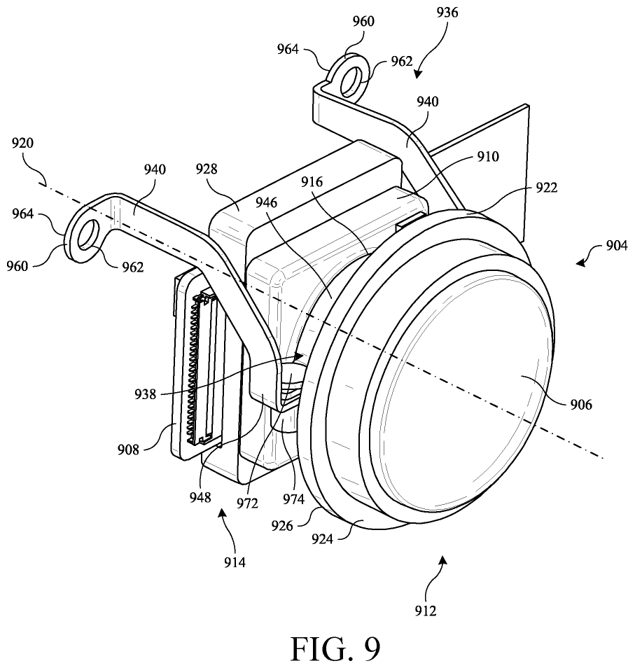

FIG. 9 is an isometric view of a third example of a bracket 936 that is connected to an ISLA 904. The ISLA 904 is similar to the ISLA 604 of FIGS. 6 and 7, and includes a lens 906, an image sensor 908, and a housing 910 that are similar to the lens 606, the image sensor 608, and the housing 610 described with respect to FIG. 6. The housing 910 includes a barrel 916, a flange 922, and an image sensor portion 928 that are similar to the barrel 616, the flange 622, and the image sensor portion 628. Like the flange 622, the flange 922 includes a first side 924 and a second side 926. Furthermore, like the barrel 616, the barrel 916 may extend from a first end 912 of the housing 910 to a second end 914 of the housing 910 along a longitudinal axis 920.

The bracket 936 may be similar to the brackets 736, 836 described with respect to FIGS. 7 and 8. The bracket 936 includes a collar 938 that is similar to the collars 738, 838 and that may include a first portion 946 and a second portion 948 that cooperatively surround the barrel 916 of the ISLA 904. The first portion 946 may be connected to the second portion 948 via a fastener 972 (e.g., a bolt, a screw, a rivet, etc.) that extends through the first portion 946 and the second portion 948. The fastener 972 may be received by a boss 974, a nut, or the like. The bracket 936 also includes mounting structures 940 that may be similar to the mounting structures 740, 840 and that extend generally away from the collar 938 to terminate at ends 960. The ends 960 of the mounting structures 940 include mounting apertures 962 and mounting surfaces 964 that are similar to the mounting apertures 762, 862 and the mounting surfaces 764, 864.

The bracket 936 may be configured to connect to a body of an image capture device that includes only two mounting features for securing an ISLA, such as the ISLA 904, thereto. Accordingly, the bracket 936 includes two of the mounting structures 940 to connect to the two mounting features of such a body. Furthermore, the bracket 936 may be configured to connect to a body of an image capture device that includes an ISLA opening and mounting features for an ISLA that are positioned on opposite (e.g., front and rear) sides of the body. To accommodate such a body configuration, the mounting structures 940 terminate at a location that, when the collar 938 is clamped around the barrel 916, is spaced from or beyond the image sensor 908 and the image sensor portion 928 of the housing 910 with respect to the longitudinal axis 920. Therefore, where a body of an image capture device includes mounting structures positioned on a rear side of the body and an ISLA opening positioned on a front side of the body, the mounting structures 940 may extend beyond the image sensor portion 928 of the housing 910 of the ISLA 904 to secure the ISLA 904 to the rear side of the body while supporting the ISLA 904 as it extends cantilevered through the body and into the ISLA opening on the front side of the body.

Furthermore, certain portions of the mounting structures 940 may contact sides of the image sensor portion 928 of the housing 910 to form a frame around the image sensor portion 928. By forming a frame around the image sensor portion 928 of the housing 910, the mounting structures 940 may inhibit rotation of the ISLA 904 about the longitudinal axis 920 and inhibit rotation between the ISLA 904 and the bracket 936. Furthermore, by contacting the image sensor portion 928 of the housing 910, the image sensor portion 928 may provide structural support to (e.g., may stiffen) the mounting structures 940 to prevent the ISLA 904 from moving relative to the body of the image capture device.

The collar 938 of the bracket 936 may include a complementary axial locating feature that is configured to interface with the axial locating feature of the housing 910 to inhibit translation of the ISLA 904 along the longitudinal axis 920 relative to the bracket 936 when the bracket 936 is secured to the ISLA 904. For example, and referring to FIG. 11B where two ISLAs 904 are coupled together using the bracket 936 of FIG. 9 and the bracket 736 of FIG. 7, the axial locating feature of the housing 910 of the ISLA 904 includes the flange 922 and the complementary axial locating feature of the collar 938 includes an elongated locator 976 that is configured to interface with (e.g., contact) the second side 926 of the flange 922. When the collar 938 is clamped around the barrel 916 (see FIG. 9), the elongated locator 976 may contact the second side 926 of the flange 922 and thereby inhibit translation of the collar 938 along the longitudinal axis 920 toward the first end 912 of the housing 910 (e.g., toward the lens 906) relative to the ISLA 904.

Still referring to FIG. 11B, the elongated locator 976 extends generally away from a first edge 942 of the collar 938. In some implementations, the elongated locator 976 may extend generally radially outward from the longitudinal axis 920 of the barrel 916 when the collar 938 is clamped around the barrel 916. The elongated locator 976 may include a surface that is complementary to the second side 926 of the flange 922. In implementations where the collar 938 is comprised of multiple portions (e.g., the first portion 946 and the second portion 948), the elongated locator 976 may extend away from only one of the first portion 946 or the second portion 948 to contact the second side 926 of the flange 922. In some implementations, the elongated locator 976 may extend away from the first portion 946 to contact the second side 926 of the flange 922 at one location and another elongated locator may extend away from the second portion 948 to contact the second side 926 of the flange 922 at another location.

Referring to FIG. 9, the bracket 936 (or portions thereof) may be formed by bending one or more metal blanks (e.g., flat metal stock that has been stamped into a pattern). For example, the first portion 946 of the collar 938 may be formed from bending a metal blank, and the second portion 948 of the collar 938 and the mounting structures 940 may be formed from bending another metal blank. In other implementations, the first portion 946 of the collar 938 and the mounting structures 940 may be formed from bending a metal blank, and the second portion 948 of the collar 938 may be formed from bending another metal blank.

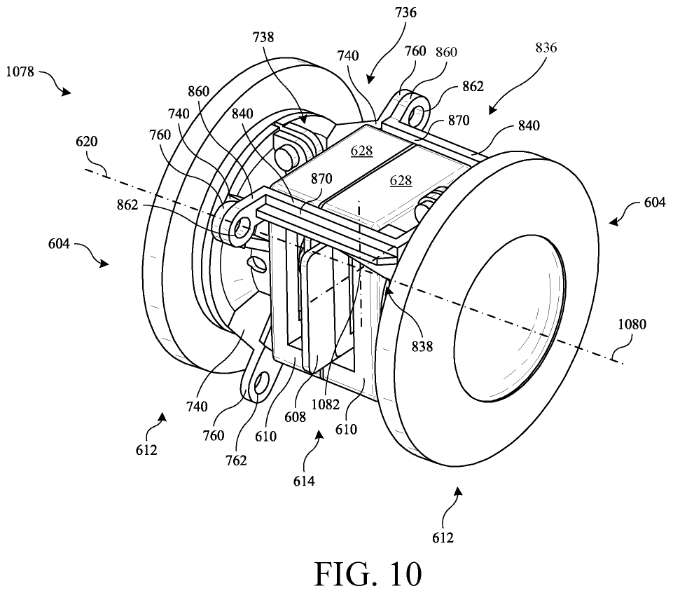

FIG. 10 is an isometric view of an ISLA assembly 1078 for an omnidirectional image capture device that includes a pair of ISLAs 604 (see FIG. 6) that are connected to each other by the bracket 736 of FIG. 7 and the bracket 836 of FIG. 8. An omnidirectional image capture device may include a body that defines a body cavity inside which the ISLA assembly 1078, or portions thereof, may be disposed. The body may include front and rear ISLA openings on opposite (e.g., front and rear) sides of the body that extend from the body cavity to an external environment. The body may include mounting features for securing an ISLA assembly, such as the ISLA assembly 1078, thereto. When the ISLA assembly 1078 is secured to the body of the omnidirectional image capture device, one of the ISLAs 604 may be disposed within the front ISLA opening and the other one of the ISLAs 604 may be disposed within the rear ISLA opening.

In the implementation shown in FIG. 10, the pair of ISLAs 604 are positioned along a common longitudinal axis 1080, such that the barrel 616 (see FIG. 6) of one of the ISLAs 604 and the barrel 616 of the other one of the ISLAs 604 are axially aligned. In such an implementation, the common longitudinal axis 1080 is consistent with the longitudinal axes 620 of the barrels 616 of the pair of ISLAs 604. In other implementations, the pair of ISLAs 604 may not be positioned along the common longitudinal axis 1080, but rather may be arranged in a Janus configuration, an offset Janus configuration, or some other configuration.

Referring to FIG. 10, the bracket 736 is configured to connect to the bracket 836 to secure (e.g., fix) the pair of ISLAs 604 relative to each other. The collar 738 of the bracket 736 is configured to clamp around the barrel 616 of one of the ISLAs 604 and the collar 838 of the bracket 836 is configured to clamp around the barrel 616 of the other one of the ISLAs 604. The ends 760 of the mounting structures 740 of the bracket 736 are configured to connect to the ends 860 of the mounting structures 840 of the bracket 836 to secure (e.g., fix) the pair of ISLAs 604 relative to each other. For example, the mounting apertures 762 of the bracket 736 may align with the mounting apertures 862 of the bracket 836. Respective fasteners (e.g., bolts, screws, etc.) may extend through the mounting apertures 762 and the mounting apertures 862 to secure the ends 760 of the mounting structures 740 to the ends 860 of the mounting structures 840.

In some implementations, only some of the mounting structures 740 of the bracket 736 may be configured to connect to the mounting structures 840 of the bracket 836. As shown in FIG. 10, for example, where the bracket 736 includes three of the mounting structures 740 and the bracket 836 includes two of the mounting structures 840, only two of the mounting structures 740 may be configured to connect to the two of the mounting structures 840.

Still referring to FIG. 10, the ends 760 of the mounting structures 740 may connect to the ends 860 of the mounting structures 840 at a location along the common longitudinal axis 1080. As described with reference to FIG. 8, the axially extending portion 870 of the mounting structures 840 may be spaced from or extend beyond the image sensor 608 and the image sensor portion 628 of the housing 610 of the ISLA 604. Accordingly, the ends 760 may connect to the ends 860 at a location along the common longitudinal axis 1080 that is offset from a center 1082 of the ISLA assembly 1078 that is defined along the common longitudinal axis 1080 between the pair of ISLAs 604 (e.g., between the image sensor portion 628 of one of the ISLAs 604 and the image sensor portion 628 of the other one of the ISLAs 604). For example, in the implementation shown in FIG. 10, the ends 760 connect to the ends 860 at a location along the common longitudinal axis 1080 that is proximate to the first end 612 of one of the ISLAs relative to the center 1082.

The bracket 736 is further configured to connect the ISLA assembly 1078 to a body of an omnidirectional image capture device. As described above, in some implementations, a body of an omnidirectional image capture device may include front and rear ISLA openings positioned on opposite (e.g., front and rear) sides of the body. Furthermore, in some implementations, a body of an omnidirectional image capture device may only include mounting features on one side of the body for securing an ISLA assembly, such as the ISLA assembly 1078, thereto. For example, a body of an omnidirectional image capture device may only include mounting features around a front ISLA opening that extends through a front side of the body and may not include mounting features around a rear ISLA opening that extends through a rear side of the body.

To accommodate such a body configuration, the mounting structures 740 of the bracket 736 may be configured to connect to the mounting features on the front side of the body to secure (e.g., fix) one of the ISLAs 604 within the front ISLA opening. Furthermore, the mounting structures 840 may be spaced from and extend beyond the image sensor portion 628 of the other one of the ISLAs 604 to connect to the ends 760 of the mounting structures 740 and thereby secure the other one of the ISLAs 604 within the rear ISLA opening. In such an implementation, the bracket 836 may support the ISLA 604 to which it is coupled as it extends cantilevered through the body of the omnidirectional image capture device and into the rear ISLA opening.

FIGS. 11A-11B are isometric views of an ISLA assembly 1178 for an omnidirectional image capture device that includes a pair of ISLAs 904 (see FIG. 9) that are connected to each other by the bracket 736 of FIG. 7 and the bracket 936 of FIG. 9. The ISLA assembly 1178 may be similar to the ISLA assembly 1078. For example, the bracket 736 may be configured to connect to the bracket 936 to secure (e.g., fix) the pair of ISLAs 904 relative to each other and along a common longitudinal axis 1180. Furthermore, the bracket 736 may be configured to connect the ISLA assembly 1178 to a body of an omnidirectional image capture device having front and rear ISLA openings on opposite (e.g., front and rear) sides of the body.

The collar 738 of the bracket 736 is configured to clamp around the barrel 916 (see FIG. 9) of one of the ISLAs 904 and the collar 938 of the bracket 936 is configured to clamp around the barrel 916 of the other one of the ISLAs 904. The ends 760 of the mounting structures 740 of the bracket 736 are configured to connect to the ends 960 of the mounting structures 940 of the bracket 936 to secure (e.g., fix) the pair of ISLAs 904 relative to each other. For example, the mounting apertures 762 of the bracket 736 may align with the mounting apertures 962 of the bracket 936. Respective fasteners 1184 (e.g., bolts, screws, etc.) may extend through the mounting apertures 762 and the mounting apertures 962 to secure the ends 760 of the mounting structures 740 to the ends 960 of the mounting structures 940.

Furthermore, the ISLA assembly 1178 may accommodate implementations of omnidirectional image capture devices that include mounting features on only one side of a body for securing an ISLA assembly, such as the ISLA assembly 1178, thereto (e.g., that include mounting features around a front ISLA opening that extends through a front side of the body and not around a rear ISLA opening that extends through a rear side of the body). Accordingly, the mounting structures 740 of the bracket 736 may be configured to connect to the mounting features on the front side of the body to secure (e.g., fix) one of the ISLAs 904 within the front ISLA opening. The mounting structures 940 of the bracket 936 may be spaced from or extend beyond the image sensor portion 928 of the other one of the ISLAs 904 to connect to the ends 760 of the mounting structures 740 and thereby secure the other one of the ISLAs 904 within the rear ISLA opening. In such an implementation, the bracket 936 may support the ISLA 904 to which it is coupled as it extends cantilevered through the body of the omnidirectional image capture device and into the rear ISLA opening.

The methods and techniques of bracket structures for camera lens assemblies described herein, or aspects thereof, may be implemented by an image capture device, or one or more components thereof, such as the image capture device 100 shown in FIGS. 1A-1B, the image capture device 200 shown in FIGS. 2A-2B, the image capture device 300 shown in FIG. 3, the image capture device 400 shown in FIGS. 4A-4B, or the image capture device 500 shown in FIG. 5. The methods and techniques of bracket structures for camera lens assemblies described herein, or aspects thereof, may be implemented by an ISLA, such as the ISLA 104 shown in FIGS. 1A-1B, one or more of the ISLAs 204, 206 shown in FIGS. 2A-2B, one or more of the ISLAs 304, 306 shown in FIG. 3, the ISLA 404 shown in FIGS. 4A-4B, or an ISLA of the image capture device 500 shown in FIG. 5.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture device, comprising:
a body;
an image sensor and lens assembly (ISLA) disposed in the body, the ISLA comprising a barrel; and
a bracket comprising:
a collar configured to removably clamp around the barrel of the ISLA; and
two or more mounting structures coupled to the collar,
wherein the two or more mounting structures extend outward from the collar and are configured to connect the collar and the ISLA to the body.

2. The image capture device of claim 1, wherein the ISLA further comprises:
an image sensor and a lens,
wherein the barrel of the ISLA extends from the image sensor to the lens and defines a longitudinal axis, and
wherein the collar is configured to removably clamp around the barrel of the ISLA between the image sensor and the lens.

3. The image capture device of claim 2, wherein:
the lens is supported by the barrel of the ISLA at a first end of the barrel;
the image sensor is supported by the barrel of the ISLA at a second end of the barrel that is opposite the first end; and
when the collar is clamped around the barrel of the ISLA, the two or more mounting structures further extend toward the second end of the barrel.

4. The image capture device of claim 3, wherein when the collar is clamped around the barrel of the ISLA, the two or more mounting structures extend toward the second end of the barrel in a direction that is substantially parallel with the longitudinal axis of the barrel and terminate at a location beyond the image sensor.

5. The image capture device of claim 1, wherein the barrel of the ISLA includes a locating feature and the collar of the bracket includes a complementary locating feature that is configured to interface with the locating feature of the barrel to releasably fix a position of the collar relative to the barrel.

6. The image capture device of claim 5, wherein the locating feature of the barrel is a pin that extends outward from the barrel and the complementary locating feature of the collar is a hole that is configured to receive the pin.

7. An image sensor and lens assembly (ISLA), comprising:
a lens;
an image sensor;
a barrel that supports the lens and extends from the image sensor to the lens to define a longitudinal axis; and
a bracket comprising:
a first portion and a second portion that are configured to cooperatively surround the barrel; and
a mounting structure configured to couple the bracket to a body of an ISLA,
wherein when the mounting structure is coupled to the body and the first portion and the second portion cooperatively surround the barrel, the bracket inhibits rotation of the ISLA about the longitudinal axis of the barrel.

8. The ISLA of claim 7, wherein the first portion of the bracket is configured to receive a first portion of the barrel, and wherein the second portion of the bracket is configured to receive a second portion of the barrel.

9. The ISLA of claim 8, wherein:
the first portion of the bracket includes a recess that is complementary to an outer surface of the first portion of the barrel; and
the second portion of the bracket includes a recess that is complementary to an outer surface of the second portion of the barrel.

10. The ISLA of claim 9, wherein:
the barrel has a first half and a second half that are defined by a plane that bisects the barrel;
the first half of the barrel is the first portion of the barrel; and
the second half of the barrel is the second portion of the barrel.

11. The ISLA of claim 7, wherein:
the barrel includes a flange that supports the lens on a first side of the flange; and
at least one of the first portion of the bracket or the second portion of the bracket includes a complementary member that is configured to contact the flange on a second side of the flange that is opposite the first side to inhibit movement of the bracket toward the lens along the longitudinal axis of the barrel.

12. The ISLA of claim 11, wherein the complementary member is a complementary flange that extends along a periphery of at least one of the first portion of the bracket or the second portion of the bracket.

13. The ISLA of claim 11, wherein the complementary member is an elongated member that extends away from at least one of the first portion of the bracket or the second portion of the bracket in a direction that is generally radially outward from the longitudinal axis of the barrel.

14. The ISLA of claim 7, wherein at least one of the first portion of the bracket or the second portion of the bracket is formed from bending a metal blank.

15. The ISLA of claim 7, wherein:
the first portion of the bracket includes an aperture;
the second portion of the bracket includes a boss; and
the ISLA further comprises a fastener that is configured to extend through the aperture of the first portion and into the boss of the second portion to couple the first portion to the second portion.

16. The ISLA of claim 7, wherein the bracket is configured to inhibit rotation of the ISLA about the longitudinal axis of the barrel by clamping around the barrel of the ISLA.

17. The ISLA of claim 7, wherein the barrel includes a feature, the bracket includes a complementary feature, and the bracket is configured to inhibit rotation of the ISLA about the longitudinal axis of the barrel when the feature of the barrel interfaces with the complementary feature of the bracket.

18. An image capture device, comprising:
a body;
a first image sensor and lens assembly (ISLA) supported by the body and oriented in a first direction, the first ISLA comprising a first barrel;
a second ISLA supported by the body and oriented in a second direction opposite to the first direction, the second ISLA comprising a second barrel;
a first bracket that clamps around the first barrel; and
a second bracket that clamps around the second barrel,
wherein the first bracket is connected to the second bracket to fix a position of the first ISLA relative to that of the second ISLA, and
wherein the second bracket is connected to the body to fix a position of the first ISLA and the second ISLA relative to the body.

19. The image capture device of claim 18, wherein:
the first bracket includes two or more mounting structures that extend away from the first barrel of the first ISLA;
the second bracket includes two or more mounting structures that extend away from the second barrel of the second ISLA;
the two or more mounting structures of the first bracket are connected to the two or more mounting structures of the second bracket to fix the position of the first ISLA relative to that of the second ISLA; and
the two or more mounting structures of the second bracket are connected to the body to fix the position of the first ISLA and the second ISLA relative to the body.

20. The image capture device of claim 19, wherein:
the first barrel of the first ISLA and the second barrel of the second ISLA are aligned on a common longitudinal axis; and
the two or more mounting structures of the first bracket are connected to the two or more mounting structures of the second bracket at a position that is longitudinally offset from a center that is defined between the first ISLA and the second ISLA.
